(19) United States
(12) Patent Application Publication
(10) Pub. No.: US 2023/0364787 A1
(43) Pub. Date: Nov. 16, 2023

(54) AUTOMATED HANDLING SYSTEMS AND METHODS

(71) Applicant: Nomagic sp z o.o., Warszawa (PL)

(72) Inventors: Marek CYGAN, Warszawa (PL); Piotr POLATOWSKI, Warszawa (PL); Kacper NOWICKI, Warszawa (PL); Konrad BANACHOWICZ, Warszawa (PL); Mikolaj ZALEWSKI, Warszawa (PL); Jakub SWIATKOWSKI, Warszawa (PL); Maciej JAKOWSKI, Warszawa (PL); Filip GRZADKOWSKI, Warszawa (PL); Tristan D'ORGEVAL, Warszawa (PL)

(21) Appl. No.: 18/042,998

(22) PCT Filed: Aug. 26, 2021
(86) PCT No.: PCT/IB2021/000588

§ 371 Date: Feb. 24, 2023

Related U.S. Application Data
(60) Provisional application No. 63/087,108, filed on Oct. 2, 2020.
(60) Provisional application No. 63/071,233, filed on Aug. 27, 2020.

(51) Int. Cl. B25J 9/16; B25J 13/08; G06T 1/00; G06T 7/62; G06T 7/00; G06K 7/14

(52) U.S. Cl. CPC B25J 9/163; B25J 13/085; G06T 1/0014; G06T 7/62; G06T 7/0006; G06K 7/1413; G06T 2207/20081; G06T 2207/20092; G06T 2200/24

(57) ABSTRACT

Provided are systems and method for automated handling of one or more objects.

### CROSS-REFERENCE

This application claims the benefit of U.S. Provisional Application No. 63/071,233 filed Aug. 27, 2020 and U.S. Provisional Application No. 63/087,108 filed Oct. 2, 2020, each of which is incorporated herein by reference in its entirety.

### SUMMARY

Provided herein are embodiments of a system for handling a plurality of objects comprising: a robotic arm for picking one or more objects of said plurality of objects from a first position and placing each object of said one or more objects at a target position, said robotic arm comprising an end effector, and a force sensor for obtaining a measured force as said end effector handles an object of said one or more objects; and a computing device comprising a processor operatively coupled to said robotic arm, and a non-transitory computer readable storage medium with a computer program including instructions executable by said processor causing said processor to analyze a force differential between a measured force received from said force sensor and an expected force of said object being handled, and instruct said robotic arm to place said object being handled at said target position if said force differential is less than a first predetermined threshold, or generate an alert if said force differential exceeds a second predetermined threshold.

In some embodiments, said processor instructs said robotic arm to place said object at an anomaly location of one or more anomaly locations if said alert is generated. In some embodiments, the system further comprises at least one optical sensor directed toward said object. In some embodiments, said at least one optical sensor reads a machine-readable code marked on said object. In some embodiments, an alert is generated if said machine-readable code is different than one or more expected machine-readable codes. In some embodiments, the system further comprises a product database in communication with said computing device, wherein said product database provides said one or more expected machine-readable codes. In some embodiments, said unique machine readable code provides said expected force.

In some embodiments, said processor of said computing device is operatively coupled to said at least one optical sensor, and wherein said processor analyzes images received by said at least optical sensor to obtain one or more grasping points on said object for said end effector. In some embodiments, said processor of said computing device is operatively coupled to said at least one optical sensor, and wherein said processor analyzes images received by said at least optical sensor to obtain one or more measured dimensions of said object and generates said alert if a difference between said one or more measured dimensions and one or more expected dimensions of said object exceeds a third predetermined threshold. In some embodiments, said at least one optical sensor reads a unique machine-readable code marked on said object, and wherein said unique machine readable code provides said one or more expected dimensions. In some embodiments, the system further comprises a product database in communication with said computing device, wherein said product database provides said one or more expected dimensions.

In some embodiments, said processor instructs said robotic arm to present said machine-readable code to said at least one optical sensor, such that said at least one optical sensor is able to scan said machine-readable code. In some embodiments, said system further comprises an operator device, wherein said processor sends alert information to said operator device when said alert is generated. In some embodiments, said alert information comprises one or more images of said object. In some embodiments, said operator device comprises a user interface for receiving input from an operator, wherein said operator inputs verification of said alert. In some embodiments, wherein said verification trains a machine learning algorithm of said computer program. In some embodiments, said machine learning algorithm changes said first predetermined threshold, said second predetermined threshold, or both. In some embodiments, said verification comprises confirming if said alert was properly generated or rejecting said alert.

In some embodiments, said target position is within a target container. In some embodiments, said first position is within a source container. In some embodiments, said measured force comprises a weight of said object. In some embodiments, said force sensor comprises a six-axis force sensor, and wherein said measured force comprises a torque force. In some embodiments, said force sensor is adjacent to a wrist joint of said robotic arm.

Provided herein are embodiments of a system for handling a plurality of objects comprising: a robotic arm for picking one or more objects of said plurality of objects from a first position and placing each object of said one or more objects at a target position, said robotic arm comprising: at least one end effector receiver for receiving at least one end effector, and an end effector stage comprising two or more end effectors; at least one optical sensor for obtaining information from said one or more objects; and a computing device comprising a processor operatively coupled to said robotic arm and said at least one optical sensor, and a non-transitory computer readable storage medium with a computer program including instructions executable by said processor causing said processor to analyze said information obtained by said optical sensor to select said at least one end effector from said two or more end effectors.

In some embodiments, said processor of said computing device is operatively coupled to said at least one optical sensor, and wherein said processor analyzes images received by said at least optical sensor to obtain one or more grasping points on said object for said end effector. In some embodiments, said processor analyzes images received by said at least optical sensor to obtain one or more measured dimensions of said object and generates an alert if a difference between said one or more measured dimensions and one or more expected dimensions of said object exceeds a third predetermined threshold.

In some embodiments, the system further comprises at least one force sensor to obtain a measured force of said object from said at least one effector handles, and wherein said processor analyzes a force differential said measured force and an expected force of an object being handled, and instructs said robotic arm to place an object being handled at said target position, or generates an alert.

Provided herein are embodiments of a device for handling a plurality of objects received at a station comprising: a robotic arm positioned at said station comprising an end effector and a force sensor; at least one image sensor to capture one or more images of one or more objects of said plurality of objects at said station; and a computing device comprising a processor operatively coupled to said at least one image sensor and said robotic arm, and a non-transitory computer readable storage medium with a computer program including instructions executable by said processor causing said processor to analyze an object of said plurality of objects to i) locate a grasping point on said object from said one or more images received by said at least one image sensor, ii) instruct said robotic arm to pick up said object, iii) analyze a measured weight of said object from said force sensor.

In some embodiments, analyzing said measured weight comprises comparing said measured weight of said object with an expected weight of said object. In some embodiments, said processor generates an alert if said measured weight is not approximately equal to said expected weight of said object. In some embodiments, said processor records an anomaly event if said alert is generated. In some embodiments, said alert is generated if said measured weight is different from said expected weight by about 5 percent or more. In some embodiments, said expected weight is received from a product database in communication with said computing device.

In some embodiments, said instructions further comprise analyzing said one or more images received by said at least one image sensor to compare determine if said object has been damaged. In some embodiments, analyzing said one or more images comprises comparing one or more measured dimensions of said object to one or more expected dimensions of said object. In some embodiments, said processor generates an alert if said one or more measured dimensions are not approximately equal to said one or more expected dimensions of said object. In some embodiments, said one or more expected dimensions are obtained from one or more reference images.

In some embodiments, said force sensor further comprises a torque sensor. In some embodiments, said force sensor is a six axis force sensor. In some embodiments, said weight is measured while said object is being moved by said robotic arm.

In some embodiments, each object of said plurality of objects comprises a machine-readable code, wherein said at least one image sensor captures one or more images of said machine-readable code and said processor analyzes said machine readable code to obtain information of said object. In some embodiments, said information comprises an expected weight of said object. In some embodiments, analyzing said measured weight comprises comparing said measured weight of said object with said expected weight of said object. In some embodiments, said processor generates an alert if said measured weight is not approximately equal to said expected weight of said object. In some embodiments, said processor records an anomaly event if said alert is generated. In some embodiments, said alert is generated if said measured weight is different from said expected weight by about 5 percent or more.

In some embodiments, said information comprises expected dimensions of said object. In some embodiments, said instructions further comprise determining measured dimensions of said object from said one or more images received by said at least one image sensor and comparing said measured dimensions to said expected dimensions to determine if said object has been damaged. In some embodiments, said processor generates an alert if said measured dimensions are not approximately equal to said expected dimensions of said object. In some embodiments, said alert is generated if said measured dimensions are different from said expected dimensions by about 5 percent or more.

In some embodiments, said information further comprises a proper orientation of said object, wherein said robotic arm manipulates said object to place said object with said proper orientation.

In some embodiments, the computing device interfaces with an existing tracking system to provide an object status to said existing tracking system. In some embodiments, the object status comprises confirmation of an object being placed at said target position, input that an anomaly has been detected, input that an object has been placed at an exception location, input that an object has left said target position, or combinations thereof.

Provided herein are embodiments of a system for automated picking and sorting of one or more objects comprising: one or more robotic devices for handling said one or more objects, each robotic device comprising: a robotic arm comprising an end effector and a force sensor; at least one image sensor to capture one or more images of said one or more objects; and a computing device comprising a processor operatively coupled to said at least one image sensor and said robotic arm, and a non-transitory computer readable storage medium with a computer program including instructions executable by said processor causing said processor to analyze an object of said plurality of objects to i) locate a grasping point on said object from said one or more images received by said at least one image sensor, ii) instruct said robotic arm to pick up said object, iii) analyze said object for anomalies, and iv) generate one or more alerts if one or more anomalies are detected; and an operator facing device comprising a processor in communication with said computing device of said one or more robotic devices, and a non-transitory computer readable storage medium with a computer program including instructions executable by said processor causing said processor display information corresponding to said one or more alerts on a display of said operator facing device.

In some embodiments, said one or more anomalies comprise a difference between a measured weight and an expected weight of said object, a difference between measured dimensions and expected dimensions of said object, or a combination thereof. In some embodiments, said difference between said measured weight and said expected weight is about 5 percent or more. In some embodiments, said measured weight is measured by said force sensor. In some embodiments, said difference between said measured dimensions and said expected dimensions is about 5 percent or more.

In some embodiments, each object of said plurality of objects comprises a machine-readable code, wherein said at least one image sensor captures one or more images of said machine-readable code and said processor analyzes said machine readable code to obtain information of said object. In some embodiments, said information comprises said expected weight of said object. In some embodiments, said information comprises said expected dimensions of said object. In some embodiments, said information further comprises a proper orientation of said object, wherein said robotic arm manipulates said object to place said object with said proper orientation.

In some embodiments, the computing device interfaces with an existing tracking system to provide an object status to said existing tracking system. In some embodiments, the object status comprises confirmation of an object being placed at said target position, input that an anomaly has been detected, input that an object has been placed at an exception location, input that an object has left said target position, or combinations thereof.

Provided herein are embodiments of a computer-implemented method for detecting anomalies in one or more objects being sorted, comprising: grasping each object of said one or more objects with a robotic arm; measuring one or more forces corresponding with said grasping of each object with a force sensor disposed on said robotic arm; analyzing a force differential between a measured force of said one or more forces and corresponding expected force; and generating an anomaly alert if said force differential exceeds a predetermined force threshold.

In some embodiments, the method further comprises imaging each object with one or more image sensors. In some embodiments, the method further comprises analyzing one or more images of each object to select an end effector for said robotic arm. In some embodiments, the method further comprises analyzing a dimensional differential between one or more measured dimensions and one or more corresponding expected dimensions; and generating said anomaly alert if said dimensional differential exceeds a predetermined dimension threshold.

In some embodiments, the method further comprises verifying said anomaly alert. In some embodiments, the method further comprises training a machine-learning algorithm. In some embodiments, training said machine-learning algorithm comprises inputting said machine-learning algorithm comprises inputting said measured force, said force differential, a verification of said anomaly alert, or a combination thereof. In some embodiments, said machine-learning algorithm changes said predetermined force threshold.

In some embodiments, the method further comprises verifying said anomaly alert and training a machine-learning algorithm, wherein training said machine-learning algorithm comprises inputting said machine-learning algorithm comprises inputting said measured force, said force differential, a verification of said anomaly alert, said one or more measured dimensions, said dimensional differential, or a combination thereof. In some embodiments, said machine-learning algorithm changes said predetermined dimension threshold.

In some embodiments, the method further comprises scanning a machine readable-code marked on each object. In some embodiments, the method further comprises obtaining said corresponding expected force for each object from said machine readable code. In some embodiments, the method further comprises generating said anomaly alert if said machine-readable code is different than one or more expected machine readable code. In some embodiments, the method further comprises scanning a machine readable-code marked on each object and obtaining said one or more corresponding expected dimensions.

In some embodiments, said one or more forces comprise a weight of said object. In some embodiments, measuring one or more forces of each object is carried out as said robotic arm moves each object from a first position to a target position. In some embodiments, said target position is within a target container.

In some embodiments, the method further comprises transmitting an object status to an object tracking system. In some embodiments, the object status comprises confirmation of an object being placed at a target position, input that an anomaly has been detected, input that an object has been placed at an exception location, input that an object has left said target position, or combinations thereof.

In some embodiments, provided herein is a method of scanning a machine-readable provided on a surface of a deformable object, the method comprising: transporting the deformable object from an initial position to a scanning position using a robotic arm comprising an end effector, wherein the end effector uses a vacuum force to grasp the deformable object; flattening the deformable object with a gas exhausted from the end effector of the robotic arm; scanning the machine-readable code on the surface of the deformable object with an image sensor; transporting the deformable object from the scanning position to a target position using the robotic arm.

In some embodiments, the step of flattening the deformable object comprises exhausting the gas from the end effector onto the deformable object while moving the end effector over the object in a flattening pattern. In some embodiments, the method further comprises a step capturing one or more images of the deformable object at the scanning position using one or more image sensors; and determining the flattening pattern based on the one or images. In some embodiments, the method further comprises a step of identifying an outline of the deformable object from the one or more images. In some embodiments, the deformable object is enclosed in a transparent plastic wrapping. In some embodiments, the method further comprises a step of imaging the deformable object at the initial position; and identifying a grasp location at which the end effector will grasp the deformable object. In some embodiments, identifying the grasp location comprises identifying at least one edge of the deformable object. In some embodiments, the method further comprises a step of identifying a location of the machine-readable code on the surface of the deformable object. In some embodiments, the grasp location is identified based on the location of the machine-readable code. In some embodiments, the robotic arm places the deformable object at the scanning position such that the machine-readable code faces the image sensor. In some embodiments, the scanning position comprises a transparent surface on which the deformable object is placed, and wherein the image sensor is provided below the transparent surface.

In some embodiments, provided herein is a system for handling a deformable object comprising: an initial position for providing the deformable object; a scanning position for scanning a machine-readable code provided on a surface of the deformable object; a target position to receive the deformable object after the machine-readable code is scanned; and a robotic arm for transporting the deformable object from the initial position to the scanning position and from the scanning position to the target position, said robotic arm comprising: an end effector for providing both a suction force to grasp the deformable object and a compressed gas to flatten the deformable object, wherein the robotic arm places the deformable object at the scanning position and flattens the deformable object using the compressed gas to ensure accurate scanning of the machine-readable code provided on the surface of the deformable object.

In some embodiments, the system comprises a compressed gas source and a vacuum mechanism. In some embodiments, the system further comprises a valve to switch between the compressed gas source and the vacuum mechanism. In some embodiments, the system comprises a vacuum mechanism which is reversible to provide both a vacuum force and a gas flow. In some embodiments, the system further comprises one or more image sensors, where at least one image sensor is provided to scan the machine-readable code. In some embodiments, the scanning position comprises a transparent surface, and wherein the at least one image sensor is provided below the transparent surface and the deformable object is placed on top of the transparent surface. In some embodiments, the one or more image sensors comprise at least one camera, wherein the at least one camera captures one or more images of the deformable object.

The system of claim 107, wherein the one or more images of the deformable object are capture at the scanning position. In some embodiments, the one or more images are utilized to generate a flattening pattern. In some embodiments, the one or more images are utilized to determine a location at which the end effector grasps the deformable object. In some embodiments, the one or more images are utilized to locate the machine-readable code.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-1B depict a handling system comprising a robotic arm, according to some embodiments;

FIG. 2 depicts an integrated computer system, according to some embodiments;

FIGS. 3A-3B depict a handling system comprising a robotic arm, according to some embodiments; and

FIG. 4 depicts a pattern performed by a robotic arm while exhausting gas toward an object being handled by a handling system, according to some embodiments.

### DETAILED DESCRIPTION

In some embodiments, provided herein are systems and methods for automation of one or more processes to sort, handle, pick, place, or otherwise manipulate one or more objects of a plurality of objects. The systems and methods may be implemented to replace tasks which may be performed manually or only in a semi-automated fashion. In some embodiments, the system and methods are integrated with machine learning software, such that an human involvement may be completely removed over time.

Robotic systems, such as a robotic arm or other robotic manipulators, may be used for applications involving picking up or moving objects. Picking up and moving objects may involve picking an object from an initial or source location and placing it at a target location. A robotic device may be used to fill a container with objects, create a stack of objects, unload objects from a truck bed, move objects to various locations in a warehouse, and transport objects to one or more target locations. The objects may be of the same type. The objects may comprise a mix of different types of objects, varying in size, mass, material, etc. Robotic systems may direct a robotic arm to pick up objects based on predetermined knowledge of where objects are in the environment. The system may comprise a plurality of robotic arms, wherein each robotic arm is transports objects to one or more target locations.

A robotic arm may retrieve a plurality of objects at one or more initial or provided locations and transport one or more objects of the plurality of objects to one or more target location. A target location may comprise a target container, a position on a conveyor or assembly system, a position within a warehouse, or any location to which the object must be transported during handling.

In some embodiments, the system comprises one or more means to detect anomalies during the handling of objects by one or more robotic manipulators. In some embodiments, the system generates an alert upon detection of an anomaly during handling. Exemplary anomalies may include detection of a misplaced object, detection of unintentionally combined objects, detection of damaged objects, or combinations thereof. Upon detection of an anomaly the system may instruct the robotic manipulator to place the object being handled into an exception location. More than one exception locations may be provided, corresponding to the type of anomaly detected. For example, in some embodiments, an object which is determined to be damaged by the system may be placed at a damaged exception location, while an object which is misplaced may be placed at a misplacement location. In some embodiments, the exception locations are provided within an exception container or box to store objects are rejected or not placed at a target position due to a detected anomaly.

### I. Robotic Arms

In some embodiments, one or more robotic manipulators of the system comprise robotic arms. In some embodiments, a robotic arm comprises one or more of robot joints connecting a robot base and an end effector receiver or end effector. A base joint may be configured to rotate the robot arm around a base axis. A shoulder joint may be configured to rotate the robot arm around a shoulder axis. An elbow joint may be configured to rotate the robot arm about an elbow axis. A wrist joint may be configured to rotate the robot arm around a wrist. A robot arm may be a six-axis robot arm with six degrees of freedom. A robot arm may comprise less or more robot joints and may comprise less than six degrees of freedom.

A robot arm may be operatively connected to a controller. The controller may comprise an interface device enabling connection and programming of the robot arm. The controller may comprise a computing device comprising a processor and software or a computer program installed there on. The computing device may can be provided as an external device. The computing device may be integrated into the robot arm.

In some embodiments, the robotic arm can implement a wiggle movement. The robotic arm may wiggle an object to help segment the box from its surroundings. In embodiments, wherein a vacuum end effector is employed, the robotic arm may employ a wiggle motion in order to create a firm seal against the object. In some embodiments, a wiggle motion may be utilized if the system detects that more than one object has been unintendedly handled by the robotic arm. In some embodiments, the robotic arm may release and re-grasp an object at another location if the system detects that more than one object has been unintendedly handled by the robotic arm.

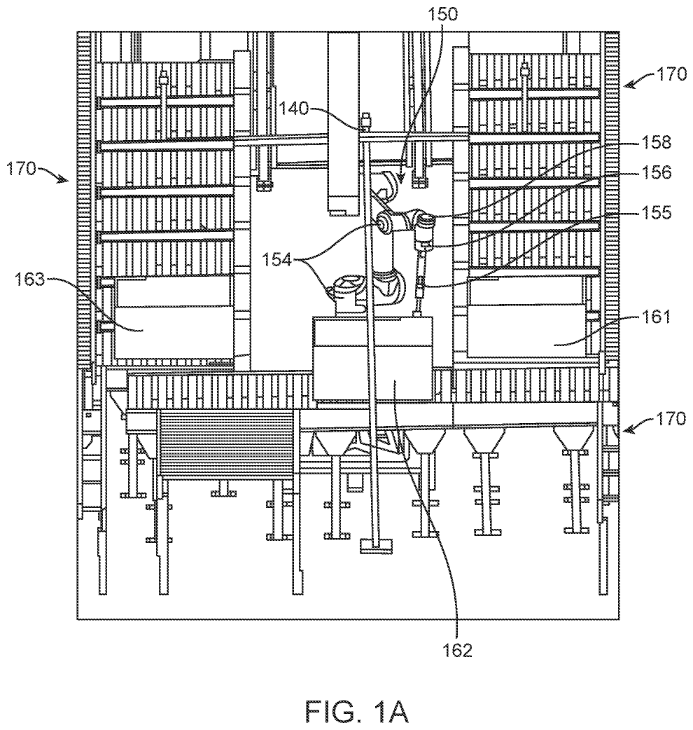

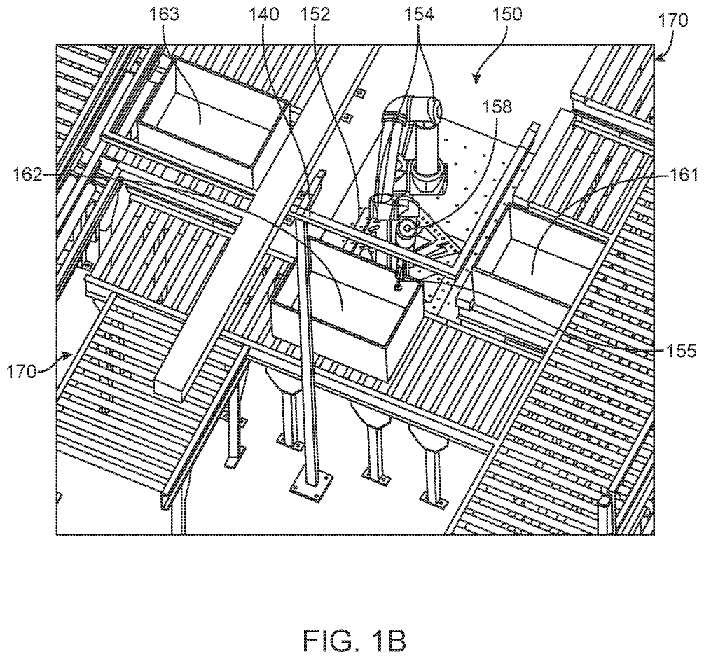

With reference to FIGS. 1A and 1B, a system for automated handling of one or more objects is depicted. In some embodiments, the system comprises a robotic arm 150. In some embodiments, the robotic arm 150 comprises at least one end effector 155 for grasping, gripping, or otherwise handling one or more objects, as described herein. In some embodiments, the robotic arm 150 comprises a base 152 and one or more joints 154 connecting the base 152 to the end effector 155. In some embodiments, the joints 154 allow the robotic arm 150 to move with six degrees of freedom.

In some embodiments, the robotic arm comprises a force sensor 156, coupled to the robotic arm 150, such that it can measure one or more forces on the effector 155 from the handling of an object. In some embodiments, the force sensor 156 is adjacent to a wrist joint 158 of the robotic arm 150. In some embodiments, an image sensor is installed on adjacent to the wrist joint 158. In some embodiments, the image is a camera.

In some embodiments, the system comprises one or more containers 161, 162, 163 for providing and receiving one or more objects to be handled. In some embodiments, the containers 161, 162, 163 are positioned near the robotic arm 150 by one or more conveyor systems 170. In some embodiments, one or more of the conveyor systems 170 continue to move as objects are placed into containers or on top of the conveyor system.

In some embodiments, one or more of the containers 161, 162, 163 are provided as source containers, wherein one or more objects are provided at a source position within the container to be picked and handled by the robotic arm 150. In some embodiments, source positions for a robotic arm retrieve one or more objects may be provided on a surface of a bench, table, shelf, conveyor system (e.g. on top of conveyor systems 170), or other apparatus suitable to support the one or more objects.

In some embodiments, one or more of the containers 161, 162, 163 are provided as target containers, wherein one or more objects are provided at a target position within one or more target containers by the robotic arm 150. Target positions for a robotic arm place one or more objects may be provided on a surface of a bench, table, shelf, conveyor system (e.g. on top of conveyor systems 170), or other apparatus suitable to support the one or more objects. In some embodiments, a target position is provided on top of another item between items adjacent to the target location, such that the object being placed at the target position is stacked or positioned between other objects for efficient packing.

In some embodiments, one or more of the containers 161, 162, 163 are provided as exception containers, if the system detects an anomaly has occurred corresponding to an object, said object will be placed at an exception position within one of the exception containers provided. In some embodiments, one or more exception containers will correspond to the type of anomaly detected. For example, an exception box may be designated to receive misplaced objects, unintentionally combined objects, or damaged objects. Exception positions for a robotic arm place one or more objects may be provided on a surface of a bench, table, shelf, conveyor system (e.g. on top of conveyor systems 170), or other apparatus suitable to support the one or more object corresponding to an anomaly. In some embodiments, an exception position is provided on top of another item between items, such that the object being placed at the exception position is stacked or positioned between other objects for efficient packing.

In some embodiments, the system comprises a frame 140. In some embodiments, the frame is configured to support the robotic arm 150 as it handles objects. In some embodiments, one or more optical sensors may be attached to the frame 140. The optical sensors may comprise image sensors to capture one or more images of objects to be handled by the robotic arm, containers for provided or receiving the objects, conveyor systems to transfer the objects or containers, and combinations thereof.

A. End Effectors

In some embodiments, various end effectors may comprise grippers, vacuum grippers, magnetic grippers, etc. In some embodiments, the robotic arm may be equipped with end effector, such as a suction gripper. In some embodiments, the gripper includes one or more suction valves that can be turned on or off either by remote sensing, single point distance measurement, and/or by detecting whether suction is achieved. In some embodiments, an end effector may include an articulated extension.

In some embodiments, the suction grippers are configured to monitor a vacuum pressure to determine if a complete seal against a surface of an object is achieved. Upon determination of a complete seal, the vacuum mechanism may be automatically shut off as the robotic manipulator continues to handle the object. In some embodiments, sections of suction end effectors may comprise a plurality of folds along a flexible portion of the end effector (i.e. bellow or accordion style folds) such that sections of vacuum end effector can fold down to conform to the surface being gripped. In some embodiments, suction grippers comprise a soft or flexible pad to place against a surface of an object, such that the pad conforms to said surface.

In some embodiments, the system comprises a plurality of end effectors to be received by the robotic arm. In some embodiments, the system comprises one or more end effector stages to provide a plurality of end effectors. Robotic arms of the system may comprise one or more end effector receivers to allow the end effectors to removable attach to the robotic arm. End effectors may include single suction grippers, multiple suction grippers, area grippers, finger grippers, and other end effector types known in the art.

In some embodiments, an end effector is selected to handle an object based on analyzation of one or more images captured by one or more image sensors, as described herein. In some embodiments, the one or more image sensors are cameras. In some embodiments, an end effector is selected to handle an object based on information received by optical sensors scanning a machine-readable code located on the object. In some embodiments, an end effector is selected to handle an object based on information received from a product database, as described herein.

B. Manipulation for Code Scanning

In some embodiments, an object to be handled by a robotic manipulator comprises a machine-readable code as described herein. In some embodiments, the manipulator begins handling of the machine readable code prior to scanning the machine-readable code. The manipulator may conduct a series of movements, to place the machine-readable code in view of one or more optical sensors.

In some embodiments, the series of movements comprises rotating the object about an axis provided by a robotic joint of a robotic arm. In some embodiments, a wrist joint rotates an object to allow an optical sensor to scan a machine-readable code provided on the object. The series of movements may further comprise releasing an object and regrasping said object using a different grasping point. Releasing and regrasping an object may occur if a machine-readable code is not detected after a series of movements or predetermined time period.

### II. Force Sensors

In some embodiments, the system comprises one or more force sensors to measure forces experienced as a robotic manipulator handles an object. In some embodiments, a force sensor is coupled to a robotic arm. In some embodiments, a force sensor is coupled to a robotic arm adjacent to a wrist joint of said robotic arm. In some embodiments, the force sensor measures forces experience as the robotic manipulator handles an object, i.e. while the object is in-flight, and does not pause or remain stationary to acquire force measurements. This may increase efficiency by decreasing the handling time of each object.

In some embodiments, one or more force sensors measure torsion forces as the robotic arm handles an object. A force sensor may measure forces with 6 degrees of freedom, measuring torque (e.g. Newton-meters (N-m) in three rotational directions and an experienced force (e.g. Newtons (N)) in three cartesian directions.

Measured forces may be analyzed to determine a mass or weight of an object being handled. The analyzation or calculation of a weight of an object may be carried out by a processor of the system, as described herein. In some embodiments, the object is handled at one or more predetermined handling points, such that the measured torsion forces will be consistent with expected torsion forces of each object. Expected torsion forces may be obtained by a machine-readable code or product database connected to the system.

In some embodiments, force sensors are integrated with conveyor systems or an apparatus which supports one or more objects. The weight of each object may be measured as the object is placed or remove from the conveyor system or apparatus which supports the object.

In some embodiments, force sensors are integrated with an end effector. If an end effector comprises a gripper, force sensors may be disposed with appendages of the gripper to measure a force produced by the gripper grasping the object. The forces of the gripper grasping an object may correspond to properties of the object, such an elasticity of the material which comprises the object being handled.

### III. Optical Sensors

A. Machine-Readable Codes

In some embodiments, the system includes one or more optical sensors. The optical sensors may be operatively coupled to at least one processor. In some embodiments, the system comprises data storage comprising instructions executable by the at least one processor to cause the system to perform functions. The functions may include causing the robotic manipulator to move at least one physical object through a designated area in space of a physical. The functions may further include causing one or more optical sensors to determine a location of a machine-readable code on the at least one physical object as the at least one physical object is moved through a target location. Based on the determined location, at least one optical sensor may scan the machine-readable code as the object is moved so as to determine information associated with the object encoded in the machine-readable code.

In some embodiments, information obtained by a machine readable code is referenced to a product database. The product database may provide information corresponding to an object being handled by a robotic manipulator, as described herein. The product database may provide information regarding a target location or position of the object and verify that the object is in a proper location.

In some embodiments, based on the information associated with the object obtained from the machine-readable code, a respective location is determined by the system at which to cause a robotic manipulator to place an object. In some embodiments, based on the information associated with the object obtained from the machine-readable code, the system may place an object at a target location.

In some embodiments, the information comprises proper orientation of an object. In some embodiments, proper orientation is referenced to the surface on which a machine-readable code is provided. Information comprising proper orientation of an object may determine the orientation at which the object is to be placed at the target position or location. Information comprises proper orientation of an object may be used to determine a grasping or handling point at which a robotic manipulator grasps, grips, or otherwise handles the object.

In some embodiments, information associated with an object obtained from at the machine-readable code may be used to determine one or more anomaly events. Anomaly events may include misplacement of the object within a warehouse or within the system, damage to the object, unintentional connection of more than one object, combinations thereof, or other anomalies which would result in an error in placing an object in an appropriate position or otherwise causing an error in further processing to take place.

In some embodiments, the system may determine that the object is at an improper location from the information associated with the object obtained from the machine-readable code. The system may generate an alert that the object is located at an improper location, as described herein. The system may place the object into at an error or exception location. The exception location may be located within a container. In some embodiments, the exception location is designated for objects which have been determined to be at an improper location within the system or within a warehouse.

In some embodiments, information associated with an object obtained from at the machine-readable code may be used to determine one or more properties of the object. The information may include expected dimensions, shapes, or images to be captured. Properties of an object may include an objects size, an objects weight, flexibility of an object, and one or more expected forces to be generated as the object is handled by a robotic manipulator.

In some embodiments, a robotic manipulator comprises the one or more optical sensors. The one or more optical sensors may be physically coupled to a robotic manipulator. In some embodiments, the system comprise multiple cameras oriented at various positions such that when one or more optical sensors are moved over an object, the optical sensors can view multiple surfaces of the object at various angles. Alternatively, the system may comprise multiple mirrors, such that mirrors so that one or more optical sensors can view multiple surfaces of an object. In some embodiments, a system comprises one or more optical sensors located underneath a platform on which the object is placed or moved over during a scanning procedure. The platform may be transparent or semi-transparent so that the optical sensors located underneath it can scan a bottom surface of the object.

In another example configuration, the robotic arm may bring a box through a reading station after or while orienting the box in a certain manner, such as in a manner in order to place the machine-readable code in a position in space where it can be easily viewed and scanned by one or more optical sensors.

B. Image Sensors

In some embodiments, the one or more optical sensors comprise one or more images sensors. The one or more image sensors may capture one or more images of an object to be handled by a robotic manipulator or an object being handled by the robotic manipulator. In some embodiments, the one or more images sensors comprise one or more cameras. In some embodiments, an image sensor is coupled to a robotic manipulator. In some embodiments, an image sensor is placed near a work station of a robotic manipulator to capture images of one or more object to be handled by the manipulator. In some embodiments, the image sensor captures images of an object being handled by a robotic manipulator.

In some embodiments, one or more image sensors comprise a depth camera. The depth camera may be a stereo camera, an RGBD (RGB Depth) camera, or the like. The camera may be a color or monochrome camera. In some embodiments, one or more image sensors comprise a RGBaD (RGB+active depth, e.g. an Intel RealSense D415 depth camera) color or monochrome camera registered to a depth sensing device that uses active vision techniques such as projecting a pattern into a scene to enable depth triangulation between the camera or cameras and the known offset pattern projector. In some embodiments, the camera is a passive depth camera. In some embodiments, cues such as barcodes, texture coherence, color, 3D surface properties, or printed text on the surface may also be used to identify an object and/or find its pose in order to know where and/or how to place the object. In some embodiments, shadow or texture differences may be employed to segment objects as well. In some embodiments, an image sensor comprises a vision processor. In some embodiments, an image sensor comprises an inferred stereo sensor system. In some embodiments, an image sensor comprises a stereo camera system.

In some embodiments, a virtual environment including a model of the objects in 2D and/or 3D may be determined and used to develop a plan or strategy for picking up the objects and verifying their properties are an approximate match to the expected properties. In some embodiments, a system uses one or more sensors to scan an environment containing objects. In an embodiment, as a robotic arm moves, a sensor coupled to the arm captures sensor data about a plurality of objects in order to determine shapes and/or positions of individual objects. A larger picture of a 3D environment may be stitched together by integrating information from individual (e.g., 3D) scans. In some embodiments, the image sensors are placed in fixed positions, on a robotic arm, and/or in other locations. According to various embodiments, scans may be constructed and used in accordance with any or all of a number of different techniques.

In some embodiments, scans are conducted by moving a robotic arm upon which one or more image sensors are mounted. Data comprising a position of the robotic arm position may provide be correlated to determine a position at which a mounted sensor is located. Positional data may also be acquired by tracking key points in the environment. In some embodiments, scans may be from fixed-mount cameras that have fields of view (FOVs) covering a given area.

In some embodiments, a virtual environment built using a 3D volumetric or surface model to integrate or stitch information from more than one sensor. This may allow the system to operate within a larger environment, where one sensor may be insufficient to cover a large environment. Integrating information from multiple sensors may yield finer detail than from a single scan alone. Integration of data from multiple sensors may reduce noise levels received by the system. This may yield better results for object detection, surface picking, or other applications.

Information obtained from the image sensors may be used to select one or more grasping points of an object. In some embodiments, information obtained from the image sensors may be used to select an end effector for handling an object.

In some embodiments, an image sensor is attached to a robotic arm. In some embodiments, the image sensor is attached to the robotic arm at or adjacent to a wrist joint. In some embodiments, an image sensor attached to a robotic arm is directed to obtain images of an object. In some embodiments, the image sensor scans a machine-readable code placed on a surface of an object.

1. Edge Detection

In some embodiments, the system may integrate edge detection software. One or more captured images may be analyzed to detect and/or locate the edges of an object. The object may be at an initial position prior to being handled by a robotic manipulator or may be in the process of being handled by a robotic manipulator when the images are captured. Edge detection processing may comprise processing one or more two-dimensional images captured by one or more image sensors. Edge detection algorithms utilized may include Canny method detection, first-order differential detection methods, second-order differential detection methods, thresholding, linking, edge thinning, phase congruency methods, phase stretch transformation (PST) methods, subpixel methods (including curve-fitting, moment-based, reconstructive, and partial area effect methods), and combinations thereof. Edge detection methods may utilize sharp contrasts in brightness to locate and detect edges of the captured images.

From the edge detection, the system may record measured dimensional values of an object, as discussed herein. The measured dimensional values may be compared to expected dimensional values of an object to determine if an anomaly event has occurred.

Anomaly events based on dimensional comparison may indicate a misplaced object, unintentionally connected objects, damage to an object, or combinations thereof. Determination of an anomaly occurrence may trigger an anomaly event, as discussed herein.

2. Image Comparison

In some embodiments, one or more images captured of an object may be compared to one or more references images. A comparison may be conducted by an integrated computing device of the system, as disclosed herein. In some embodiments, the one or more reference images are provided by a product database. Appropriate reference images may be correlated to an object by correspondence to a machine-readable code provided on the object.

In some embodiments, the system may compensate for variations in angles and distance at which the images are captured during the analysis. In some embodiments, an anomaly alert is generated if the difference between one or more captured images of an object and one or more reference images of the object exceeds a predetermined threshold. A difference one or more captured images and one or more reference images may be taken across one or more dimensions or may be a sum difference between the one or more images.

In some embodiments, reference images are sent to an operator during a verification process. The operator may view the one or more references images in relation to the one or more captured images to determine if generation of an anomaly event or alert was correct. The operator may view the reference images in a comparison module. The comparison module may present the reference images side-by-side with the captured images.

### IV. Anomaly Detection

Systems provided herein may be configured to detect anomalies of which occur during the handling and/or processing of one or more objects. In some embodiments, a system obtains one or more properties of an object prior to being handled by a robotic manipulator and analyzes the obtained properties against one or more expected properties of the object. In some embodiments, a system obtains one or more properties of an object while being handled by a robotic manipulator and analyzes the obtained properties against one or more expected properties of the object. In some embodiments, a system obtains one or more properties of an object after being handled by a robotic manipulator and analyzes the obtained properties against one or more expected properties of the object. In some embodiments, if an anomaly is detected, the system does not proceed to place the object at a target position. The system may instead instruct a robotic manipulator to place the object at an exception position, as described herein. In some embodiments, the system may verify a registered anomaly with an operator prior to placing an object at a given position.

In some embodiments, one or more optical sensors scan a machine-readable code provided on an object. Information obtained by the machine-readable code may be used to verify that an object is in a proper location. If it is determined that an object is misplaced, the system may register an anomaly event corresponding to a misplacement of said object. In some embodiments, the system generates an alert if an anomaly event is registered.

In some embodiments, the system measures one or more forces generated by an object being handled by the system. The forces may be measured by one or more force sensors as described herein. Expected forces may be provided by a product database or machine readable code, as described herein. In some embodiments, if a measured force differs from a corresponding expected force, the system registers an anomaly event. In some embodiments, an anomaly event is registered if the difference between an expected force and measured force exceeds a predetermined threshold. In some embodiments, the predetermined threshold includes a standard deviation between similar objects to be handled by the system. In some embodiments, the predetermined threshold includes a standard deviation of different of one or more objects of the same type. In some embodiments, the system generates an alert if an anomaly event is registered. In some embodiments, the predetermined threshold includes standard deviation is multiplied by a constant factor.

In some embodiments, an anomaly event is registered if a difference between a measured force and an expected force is 1 percent to 30 percent. In some embodiments, an anomaly event is registered if a difference between a measured force and an expected force is 1 percent to 2 percent, 1 percent to 3 percent, 1 percent to 5 percent, 1 percent to 7 percent, 1 percent to 10 percent, 1 percent to 15 percent, 1 percent to 20 percent, 1 percent to 30 percent, 2 percent to 3 percent, 2 percent to 5 percent, 2 percent to 7 percent, 2 percent to 10 percent, 2 percent to 15 percent, 2 percent to 20 percent, 2 percent to 30 percent, 3 percent to 5 percent, 3 percent to 7 percent, 3 percent to 10 percent, 3 percent to 15 percent, 3 percent to 20 percent, 3 percent to 30 percent, 5 percent to 7 percent, 5 percent to 10 percent, 5 percent to 15 percent, 5 percent to 20 percent, 5 percent to 30 percent, 7 percent to 10 percent, 7 percent to 15 percent, 7 percent to 20 percent, 7 percent to 30 percent, 10 percent to 15 percent, 10 percent to 20 percent, 10 percent to 30 percent, 15 percent to 20 percent, 15 percent to 30 percent, or 20 percent to 30 percent. In some embodiments, an anomaly event is registered if a difference between a measured force and an expected force is 1 percent, 2 percent, 3 percent, 5 percent, 7 percent, 10 percent, 15 percent, 20 percent, or 30 percent. In some embodiments, an anomaly event is registered if a difference between a measured force and an expected force is at least 1 percent, 2 percent, 3 percent, 5 percent, 7 percent, 10 percent, 15 percent, or 20 percent. In some embodiments, an anomaly event is registered if a difference between a measured force and an expected force is at most 2 percent, 3 percent, 5 percent, 7 percent, 10 percent, 15 percent, 20 percent, or 30 percent.

In some embodiments, the system measures one or more dimensions of an object being handled by the system. The dimensions may be measured by one or more image sensors as described herein. Expected dimensions may be provided by a product database or machine readable code, as described herein. In some embodiments, if a measured dimension differs from a corresponding expected dimension, the system registers an anomaly event. In some embodiments, an anomaly event is registered if the difference between an expected dimension and measured dimension exceeds a predetermined threshold. In some embodiments, the predetermined threshold includes a standard deviation between similar objects to be handled by the system. In some embodiments, the predetermined threshold includes a standard deviation of different of one or more objects of the same type. In some embodiments, the standard deviation is multiplied by a constant factor. In some embodiments, the system generates an alert if an anomaly event is registered.

In some embodiments, an anomaly event is registered if a difference between a measured dimension and an expected dimension is 1 percent to 30 percent. In some embodiments, an anomaly event is registered if a difference between a measured dimension and an expected dimension is 1 percent to 2 percent, 1 percent to 3 percent, 1 percent to 5 percent, 1 percent to 7 percent, 1 percent to 10 percent, 1 percent to 15 percent, 1 percent to 20 percent, 1 percent to 30 percent, 2 percent to 3 percent, 2 percent to 5 percent, 2 percent to 7 percent, 2 percent to 10 percent, 2 percent to 15 percent, 2 percent to 20 percent, 2 percent to 30 percent, 3 percent to 5 percent, 3 percent to 7 percent, 3 percent to 10 percent, 3 percent to 15 percent, 3 percent to 20 percent, 3 percent to 30 percent, 5 percent to 7 percent, 5 percent to 10 percent, 5 percent to 15 percent, 5 percent to 20 percent, 5 percent to 30 percent, 7 percent to 10 percent, 7 percent to 15 percent, 7 percent to 20 percent, 7 percent to 30 percent, 10 percent to 15 percent, 10 percent to 20 percent, 10 percent to 30 percent, 15 percent to 20 percent, 15 percent to 30 percent, or 20 percent to 30 percent. In some embodiments, an anomaly event is registered if a difference between a measured dimension and an expected dimension is 1 percent, 2 percent, 3 percent, 5 percent, 7 percent, 10 percent, 15 percent, 20 percent, or 30 percent. In some embodiments, an anomaly event is registered if a difference between a measured dimension and an expected dimension is at least 1 percent, 2 percent, 3 percent, 5 percent, 7 percent, 10 percent, 15 percent, or 20 percent. In some embodiments, an anomaly event is registered if a difference between a measured dimension and an expected dimension is at most 2 percent, 3 percent, 5 percent, 7 percent, 10 percent, 15 percent, 20 percent, or 30 percent.

In some embodiments, the system compares one or more images of an object to one or more reference images corresponding to said object. The images may be captured by one or more image sensors as described herein. Reference images may be provided by a product database or machine readable code, as described herein. In some embodiments, if one or more captured images differ from a corresponding one or more captured images, the system registers an anomaly event. In some embodiments, an anomaly event is registered if the differences between one or more reference images and one or more captured images exceed a predetermined threshold. In some embodiments, the predetermined threshold may be a standard deviation between similar objects to be handled by the system. In some embodiments, the predetermined threshold includes a standard deviation of different of one or more objects of the same type. In some embodiments, the standard deviation is multiplied by a constant factor. In some embodiments, the system generates an alert if an anomaly event is registered.

In some embodiments, an anomaly event is registered if a sum of differences between captured images of an object and reference images of said object is 1 percent to 30 percent. In some embodiments, an anomaly event is registered if a sum of differences between captured images of an object and reference images of said object is 1 percent to 2 percent, 1 percent to 3 percent, 1 percent to 5 percent, 1 percent to 7 percent, 1 percent to 10 percent, 1 percent to 15 percent, 1 percent to 20 percent, 1 percent to 30 percent, 2 percent to 3 percent, 2 percent to 5 percent, 2 percent to 7 percent, 2 percent to 10 percent, 2 percent to 15 percent, 2 percent to 20 percent, 2 percent to 30 percent, 3 percent to 5 percent, 3 percent to 7 percent, 3 percent to 10 percent, 3 percent to 15 percent, 3 percent to 20 percent, 3 percent to 30 percent, 5 percent to 7 percent, 5 percent to 10 percent, 5 percent to 15 percent, 5 percent to 20 percent, 5 percent to 30 percent, 7 percent to 10 percent, 7 percent to 15 percent, 7 percent to 20 percent, 7 percent to 30 percent, 10 percent to 15 percent, 10 percent to 20 percent, 10 percent to 30 percent, 15 percent to 20 percent, 15 percent to 30 percent, or 20 percent to 30 percent. In some embodiments, an anomaly event is registered if a sum of differences between captured images of an object and reference images of said object is 1 percent, 2 percent, 3 percent, 5 percent, 7 percent, 10 percent, 15 percent, 20 percent, or 30 percent. In some embodiments, an anomaly event is registered if a sum of differences between captured images of an object and reference images of said object is at least 1 percent, 2 percent, 3 percent, 5 percent, 7 percent, 10 percent, 15 percent, or 20 percent. In some embodiments, an anomaly event is registered if a sum of differences between captured images of an object and reference images of said object is at most 2 percent, 3 percent, 5 percent, 7 percent, 10 percent, 15 percent, 20 percent, or 30 percent.

In some embodiments, an anomaly event may be categorized. The anomaly event may be categorized based on a type of anomaly detected. For example, if an image sensor captures images of an object which differ from reference images of said object, but the force sensor indicates that the object's measured weight matches an expected weight of said object, then the system may register an anomaly event as a damaged object anomaly.

In some embodiments, the actions taken by the system correspond to the type of anomaly being register. For example, if the system registers an anomaly wherein a product has been misplaced, the system may place said object into at an exception position corresponding to a misplacement anomaly, as disclosed herein.

### V. Human in the Loop

In some embodiments, the system communicates with an operator or other user. The system may communicate with an operator using a computing device. The computing device may be an operator device. The computing device may be configured to receive input from an operator or user with a user interface. The operator device may be provided at a location remote from the handling system and operations.

In some embodiments, an operator utilizes an operator device connected to the system to verify one or more anomaly events or alerts generated by the system. In some embodiments, the operator device receives captured images from one or more image sensors of the system to verify that an anomaly has occurred in an object. An operator may provide verification that an object has been misplaced or that an object has been damaged based on the one or more images captured by the system and communicated to the operator device.

In some embodiments, captured images are provided in a module to be displayed on a screen of an operator device. In some embodiments, the module displays the one or more captured images adjacent to one or more reference images corresponding to said object. In some embodiments, one or more captured images are displayed on a page adjacent to a page displaying one or more reference images.

In an embodiment, an operator uses an interface of the operating device to verify that an anomaly event or alert was correctly generated. Verification provided by the operator may be used to train a machine learning algorithm, as disclosed herein. In some embodiments, verification that an alert was correctly generated adjusts a predetermined threshold which is used to generate an alert if a difference between one or more measured properties and one or more corresponding expected properties of an object exceed said predetermined threshold. In some embodiments, verification that an alert was incorrectly generated adjusts a predetermined threshold which is used to generate an alert if a difference between one or more measured properties and one or more corresponding expected properties of an object exceed said predetermined threshold.

In some embodiments, verification of an alert instructs a robotic manipulator to handle an object in a particular manner. For example, if an anomaly alert corresponding to an object is verified as being correctly generated, the robotic manipulator may place the object at an exception location. In some embodiments, if an anomaly alert corresponding to an object is verified as being incorrectly generated, the robotic manipulator may place the object at a target location. In some embodiments, if an alert is generated and an operator verifies that two or more objects are unintentionally being handled simultaneously, then the robotic manipulator performs a wiggling motion in an attempt to separate the two or more objects.

In some embodiments, one or more images of a target container or target location wherein one or more objects are provided at are transmitted to an operator or user device. An operator or user may then verify that the one or more objects are correctly placed at the target location or with a target container. A user or operator may also provide feedback using an operator or user device to communicate errors if the one or more objects have been incorrectly placed at the target location or within the target container.

### VI. Warehouse Integration

The systems and methods disclosed herein may be implemented in existing warehouses to automate one or more processes within a warehouse. In some embodiments, software and robotic manipulators of the system are integrated with the existing warehouse systems to provide a smooth transition of manual operations being automated.

A. Product Database

In some embodiments, a product database is provided in communication with the systems disclosed herein. The product database may comprise a library of object to be handled by the system. The product database may include properties of each objects to be handled by the system. In some embodiments, the properties of the objects provided by the product data base are expected properties of the objects. The expected properties of the objects may be compared to measured properties of the objects in order to determine if an anomaly has occurred.

Expected properties may include expected dimensions, expected forces, expected weights, and expected machine-readable codes, as disclosed herein. Product databases may be updated according to the objects to be handled by the system. Product databases may be generated input of information of the objects to be handled by handled by the system.

In some embodiments, objects may be processed by the system to generate a product database. For example, an undamaged object may be handled by one or more robotic manipulators to determine expected properties of the object. Expected properties of the object may include expected dimensions, expected forces, expected weights, and expected machine-readable codes, as disclosed herein. The expected properties determined by the system may then be input into the product database.

In some embodiments, the system may process a plurality of objects of the same type to determine a standard deviation occurring within objects of that type. The determined standard deviations may be used to set a predetermined threshold, wherein a difference between expected properties and measured properties of an object may trigger an anomaly alert. In some embodiments, the predetermined threshold includes a standard deviation of different of one or more objects of the same type. In some embodiments, the standard deviation is multiplied by a constant factor to set a predetermined threshold

B. Object Tracking

In some embodiment, the system tracks objects as they are handled. In some embodiments, the system integrates with existing tracking software of a warehouse which the system is implemented within. The system may connect with existing software such that information which is normally received by manual input is now communicated electronically by the system.

Object tracking by the system may include confirming an object has been received at a source locations or station. Object tracking by the system may include confirming an object has been placed at a target position. Object tracking by the system may include input that an anomaly has been detected. Object tracking by the system may include input that an object has been placed at an exception location. Object tracking by the system may include input that an object or target container has left a handling station or target position to be further processed at another location within a warehouse.

### VII. Accurate Scanning of Deformable Objects

In some embodiments, a system herein is provided to accurately scan deformable objects. Deformable objects may include garments, articles of clothing, or any objects which have little rigidity and may be easily folded. In some embodiments, the deformable objects may be placed inside of a plastic wrapping.

In some embodiments, a machine-readable code is provided on a surface of the deformable object. The machine-readable code may be adhered or otherwise attached to a surface of the object. In some embodiments, wherein the deformable object is provided inside of a plastic wrapping, the plastic wrapping is transparent such that the machine-readable code is scannable/readable through the plastic wrapping. In some embodiments, the machine readable code is provided on a surface of the plastic wrapping.

Accurate scanning of deformable objects may be challenging, as folds and wrinkles in the object may render the provided machine-readable code as unscannable. In some embodiments, systems and methods are provided for accurate scanning of deformable objects during an automated pick and place process.

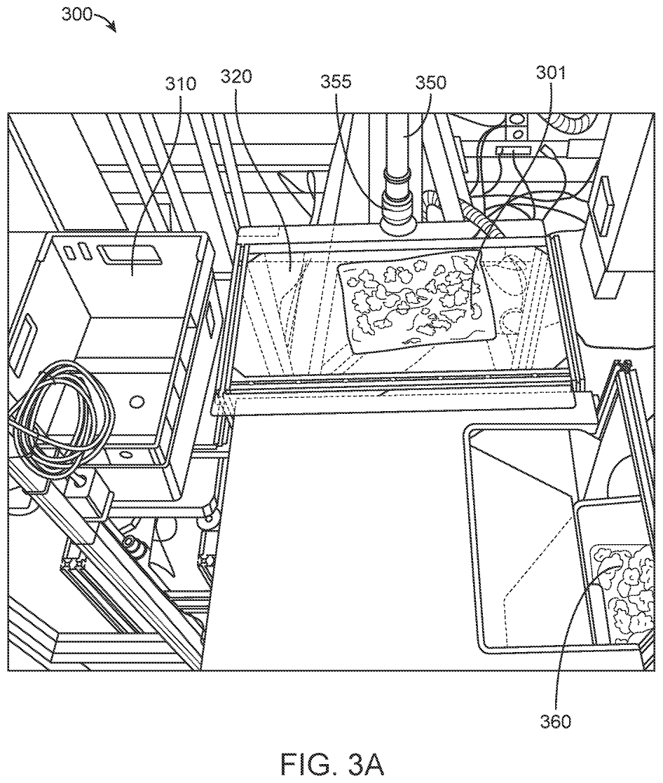

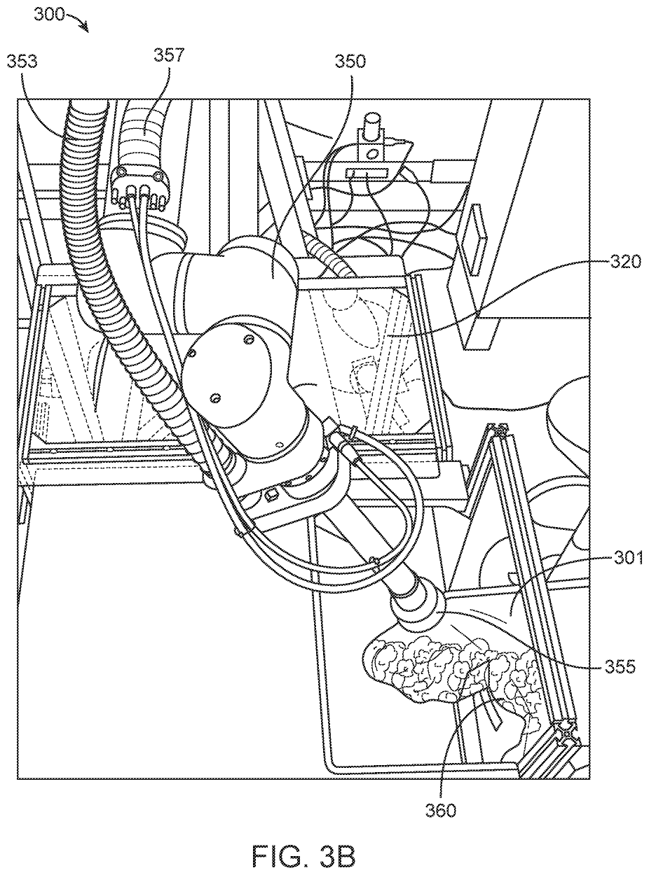

With reference to FIGS. 3A and 3B, a system 300 for picking, scanning, and placing one or more deformable objects 301 is depicted. In some embodiments, the system comprises at least one initial position 310 for providing one or more deformable objects to be transported to a target location 360. In some embodiments, a deformable object 301 is retrieved from an initial position 310 using a robotic manipulator 350, as described herein. In some embodiments, the robotic manipulator 350 transports the deformable object 301 using a suction force provided at an end effector 355 to grasp the object.

In some embodiments, the system further comprises a scanning position 320. The scanning position 320 may comprise a substantially flat surface, on which a deformable object 301 is placed by the robotic manipulator. In some embodiments, after the deformable object is placed onto at the scanning position 320, the end effector 355 releases the suction force and is separated from and raised above the deformable object. In some embodiments, the system is configured such that a gas is exhausted from the end effector 355 and onto the deformable object 301, such that the deformable object is flattened on the surface of the scanning position 320. In some embodiments, the exhausted gas is compressed air. In some embodiments, the end effector 355 then passes over the deformable object 301 while exhausting gas toward the object 301 to ensure the object is flattened against the surface of the scanning position 320. In some embodiments, after the object 301 is flattened, a machine-readable code (not shown) is scanned by an image sensor.

In some embodiments, the suction force at the end effector 355 is provided by a vacuum source which translates a vacuum via a vacuum tube 353. In some embodiments, compressed gas at the end effector 355 is provided by a compressed gas source and transmitted to the end effector via compressed air line 357. In some embodiments, the vacuum source and the compressed gas source are the same mechanism, and the air path is reversed switch between a vacuum and compressed gas stream. In some embodiments, the vacuum source and compressed gas source are separate, and a valve is provided to switch between the suction and exhaustion at the end effector.

In some embodiments, the end effector 355 is moved in a pattern (as depicted in FIG. 6) while exhausting gas onto the object 301. In some embodiments, after completing the pattern, the machine-readable code provided on the object is scanned. In some embodiments, the image sensor scans for the machine-readable code as the end effector is exhausting gas onto the object and the end effector stops exhausting gas onto the object once the code is successfully scanned. In some embodiments, if the code is not successfully scanned after the end effector completes a pattern of exhausting air onto the object, the object is again picked up by the robotic manipulator and again placed onto the surface of the scanning position. In some embodiments, the robotic manipulator repositions the object during a second or subsequent placement of the object on the surface of the scanning position. In some embodiments, the robotic manipulator flips the object over during a second or subsequent placement of the object onto the surface of the scanning position. In some embodiments, if scanning of the object is not successful after a predetermined number of attempts, an anomaly alert is generated, as disclosed herein.

In some embodiments, the image sensor which scans the machine-readable code is provided above the surface of the scanning position 320. In some embodiments, the surface of the scanning position 320 is transparent and the image sensor which scans the machine-readable code is provided below the surface of the scanning position 320. In some embodiments, the image sensor is attached to the robotic arm. The image sensor may be attached to or adjacent to a wrist joint of the robotic arm.

In some embodiments, one or more image sensors capture images of a deformable object 301 at an initial position 310. In some embodiments, the system detects one or more edges of the deformable object and selects a grasping point at which the robotic manipulator will grasp the object using a suction force provided by end effector 355 based on the location of the detected edges. In some embodiments the system detects a location of a machine-readable code and selects a grasping point at which the robotic manipulator will grasp the object using a suction force provided by end effector 355 based on the location of the machine-readable code. In some embodiments, the system orients the object 301 on the surface of the scanning position 320 based on the location of a machine-readable code.

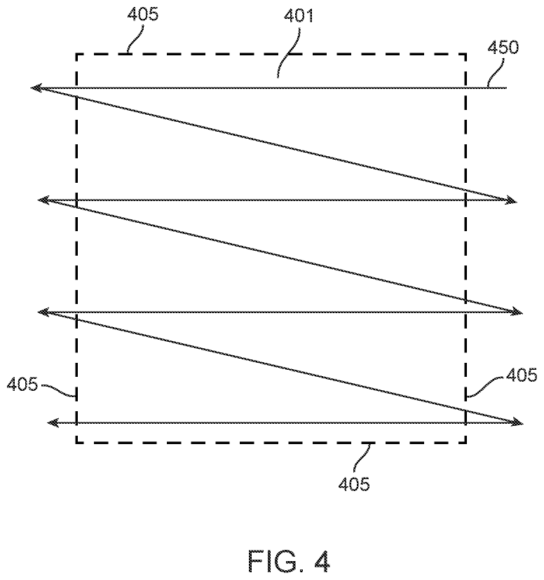

FIG. 4 depicts an exemplary flattening pattern 450 which is performed by the robotic manipulator while exhausting gas from the end effector toward a deformable object 401. In some embodiments, the flattening pattern 450 is based off of the dimensions of one or more edges 405 of the deformable object. In some embodiments, the dimensions of the one or more edges 405 are provided by a database containing information of the objects to be handled by the system. In some embodiments, the dimensions of the one or more edges 405 are detected and/or measured one or more image sensors which capture one or more images of the object 401. In some embodiments, the one or more images of the object 401 are captured after the object has been placed at a scanning position. FIG. 4 depicts just one example of a flattening pattern, according to some embodiments. One skilled in the art would appreciate that various flattening patterns could be utilized to flatten a deformable object.

### VIII. Integrated Software

Many or all of the functions of a robotic device may be controlled by a control system. A control system may include at least one processor that executes instructions stored in a non-transitory computer readable medium, such as a memory. The control system may also comprise a plurality of computing devices that may serve to control individual components or subsystems of the robotic device.

In some embodiments, a memory comprises instructions (e.g., program logic) executable by the processor to execute various functions of robotic device described herein. A memory may comprise additional instructions as well, including instructions to transmit data to, receive data from, interact with, and/or control one or more of a mechanical system, a sensor system, a product database, an operator system, and/or the control system.

A. Machine Learning Integration

In some embodiments, machine learning algorithms are implemented such that systems and methods disclosed herein become completely automated. In some embodiments, verification steps completed by a human operator are removed after training of machine learning algorithms are complete.

In some embodiments, the machine learning programs utilized incorporate a supervised learning approach. In some embodiments, the machine learning programs utilized incorporate a reinforcement learning approach. Information such as verification of alerts/anomaly events, measured properties of objects being handled, and expected properties of objects being handled by be received by a machine learning algorithm for training.

Other machine learning approaches such as unsupervised learning, feature learning, topical modeling, dimensionality reduction, and meta learning may be utilized by the system. Supervised learning may include active learning algorithms, classification algorithms, similarity learning algorithms, regressive learning algorithms, and combinations thereof.

Models used by the machine learning algorithms of the system may include artificial neural network models, decision tree models, support vector machines models, regression analysis models, Bayesian network models, training models, and combinations thereof.

Machine learning algorithms may be applied to anomaly detection, as described herein. In some embodiments, machine learning algorithms are applied to programed movement of one or more robotic manipulators. Machine learning algorithms applied to programmed movement of robotic manipulators may be used to optimize actions such as scanning a machine-readable code provided on an object. Machine learning algorithms applied to programmed movement of robotic manipulators may be used to optimize actions such performing a wiggling motion to separate unintentionally combined objects. Machine learning algorithms applied to programmed movement of robotic manipulators may be used to any actions of a robotic manipulator for handling one or more objects, as described herein.

B. Trajectory Optimization

In some embodiments, trajectories of items handled by robotic manipulators are automatically optimized by the systems disclosed herein. In some embodiments, the system automatically adjusts the movements of the robotic manipulators to achieve a minimum transportation time while preserving constraints on forces exerted on the item or package being transported.

In some embodiments, the system monitors forces exerted on the object as they are transported from a source position to a target position, as described herein. The system may monitor acceleration and/or rate of acceleration (i.e. jerk) of an object being transported by a robotic manipulator. The force experienced by the object as it is manipulated may be calculated using the known movement of the robotic manipulator (e.g. position, velocity, and acceleration values of the robotic manipulator as it transports the object) and force values obtained by the weight/torsion and force sensors provided on the robotic manipulator.

In some embodiments, optical sensors of the system monitor the movement of objects being transported by the robotic manipulator. In some embodiments, the trajectory of objects is optimized to minimize transportation time including scanning of a digital code on the object. In some embodiments, the optical sensors recognize defects in the objects or packaging of objects as a result of mishandling (e.g. defects caused by forces applied to the object by the robotic manipulator). In some embodiments, the optical sensors monitor the flight or trajectory of objects being manipulated for cases which the objects are dropped. In some embodiments, detection of mishandling or drops will result in adjustments of the robotic manipulator (e.g. adjustment of trajectory or forces applied at the end effector). In some embodiments, the constraints and optimized trajectory information will be stored in the product database, as described herein. In some embodiments, the constraints are derived from a history of attempts for the specific object or plurality of similar objects being transported. In some embodiments, the system is trained by increasing the speed at which an object is manipulated over a plurality of attempts until a drop or defect occurs due to mishandling by the robotic manipulator.

In some embodiments, a technician verifies that a defect or drop has occurred due to mishandling. Verification may include viewing a video recording of the object being handled and confirming that a drop or defect was likely due to mishandling by the robotic manipulator.

C. Computer Systems

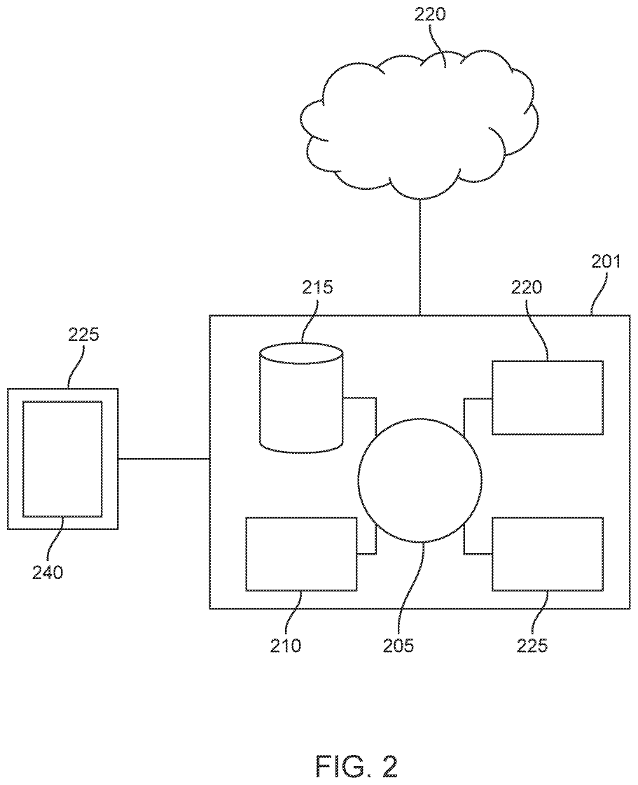

The present disclosure provides computer systems that are programmed to implement methods of the disclosure. FIG. 2 depicts a computer system 201 that is programmed or otherwise configured as a component of automated handling systems disclosed herein and/or to perform one or more steps of methods of automated handling disclosed herein. The computer system 201 can regulate various aspects of automated of the present disclosure, such as, for example, providing verification functionality to an operator, communicating with a product database, and processing information obtained from components of automated handling systems disclosed herein. The computer system 201 can be an electronic device of a user or a computer system that is remotely located with respect to the electronic device. The electronic device can be a mobile electronic device.

The computer system 201 includes a central processing unit (CPU, also “processor” and “computer processor” herein) 205, which can be a single core or multi core processor, or a plurality of processors for parallel processing. The computer system 201 also includes memory or memory location 210 (e.g., random-access memory, read-only memory, flash memory), electronic storage unit 215 (e.g., hard disk), communication interface 220 (e.g., network adapter) for communicating with one or more other systems, and peripheral devices 225, such as cache, other memory, data storage and/or electronic display adapters. The memory 210, storage unit 215, interface 220 and peripheral devices 225 are in communication with the CPU 205 through a communication bus (solid lines), such as a motherboard. The storage unit 215 can be a data storage unit (or data repository) for storing data. The computer system 201 can be operatively coupled to a computer network (“network”) 230 with the aid of the communication interface 220. The network 230 can be the Internet, an internet and/or extranet, or an intranet and/or extranet that is in communication with the Internet. The network 230 in some cases is a telecommunication and/or data network. The network 230 can include one or more computer servers, which can enable distributed computing, such as cloud computing. The network 230, in some cases with the aid of the computer system 201, can implement a peer-to-peer network, which may enable devices coupled to the computer system 201 to behave as a client or a server.

The CPU 205 can execute a sequence of machine-readable instructions, which can be embodied in a program or software. The instructions may be stored in a memory location, such as the memory 210. The instructions can be directed to the CPU 205, which can subsequently program or otherwise configure the CPU 205 to implement methods of the present disclosure. Examples of operations performed by the CPU 205 can include fetch, decode, execute, and writeback.

The CPU 205 can be part of a circuit, such as an integrated circuit. One or more other components of the system 201 can be included in the circuit. In some cases, the circuit is an application specific integrated circuit (ASIC).

The storage unit 215 can store files, such as drivers, libraries and saved programs. The storage unit 215 can store user data, e.g., user preferences and user programs. The computer system 201 in some cases can include one or more additional data storage units that are external to the computer system 201, such as located on a remote server that is in communication with the computer system 201 through an intranet or the Internet.

The computer system 201 can communicate with one or more remote computer systems through the network 230. For instance, the computer system 201 can communicate with a remote computer system of a user (e.g., a mediator computer). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 201 via the network 230.

Methods as described herein can be implemented by way of machine (e.g., computer processor) executable code stored on an electronic storage location of the computer system 201, such as, for example, on the memory 210 or electronic storage unit 215. The machine executable or machine readable code can be provided in the form of software. During use, the code can be executed by the processor 205. In some cases, the code can be retrieved from the storage unit 215 and stored on the memory 210 for ready access by the processor 205. In some situations, the electronic storage unit 215 can be precluded, and machine-executable instructions are stored on memory 210.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 201 can include or be in communication with an electronic display 235 that comprises a user interface (UI) 240 for providing, for example, health crisis management. Examples of UI's include, without limitation, a graphical user interface (GUI) and web-based user interface.

### IX. Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof.

The terms “determining,” “measuring,” “evaluating,” “assessing,” and “analyzing” are often used interchangeably herein to refer to forms of measurement. The terms include determining if an element is present or not (for example, detection). These terms can include quantitative, qualitative or quantitative and qualitative determinations. Assessing can be relative or absolute. “Detecting the presence of” can include determining the amount of something present in addition to determining whether it is present or absent depending on the context.

As used herein, the term “about” a number refers to that number plus or minus 10% of that number. The term “about” a range refers to that range minus 10% of its lowest value and plus 10% of its greatest value.

The section headings used herein are for organizational purposes only and are not to be construed as limiting the subject matter described.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1.-111. (canceled)

112. A system for handling a plurality of objects, comprising:
a robotic arm configured to pick one or more objects of said plurality of objects from a first position and place each object of said one or more objects at a target position, said robotic arm comprising:
(i) at least one end effector receiver configured to receive at least one end effector, and
(ii) an end effector stage comprising two or more end effectors;
at least one optical sensor configured to obtain information from said one or more objects; and
a computing device comprising:
(i) a processor operatively coupled to said robotic arm and said at least one optical sensor, and
(ii) one or more non-transitory computer readable storage media with a computer program including instructions, that when executed by said processor, cause said processor to analyze said information obtained by said optical sensor to select said at least one end effector from said two or more end effectors.

113. The system of claim 112, wherein said at least one optical sensor is configured to read a machine-readable code marked on at least one of said one or more objects.

114. The system of claim 113, wherein an alert is generated if said machine-readable code is different than one or more expected machine-readable codes.

115. The system of claim 114, further comprising a product database in communication with said computing device, wherein said product database provides said one or more expected machine-readable codes.

116. The system of claim 112, wherein said instructions, when executed by said processor, further cause said processor to:
(i) analyze images received by said at least optical sensor to obtain one or more measured dimensions of at least one of said one or more objects, and
(ii) generate an alert if a difference between said one or more measured dimensions and one or more expected dimensions of said at least one of said one or more objects exceeds a predetermined threshold.

117. The system of claim 116, wherein said at least one optical sensor is configured to read a machine-readable code marked on said at least one of said one or more objects, and wherein said machine readable code provides said one or more expected dimensions.

118. The system of claim 117, wherein said instructions, when executed by said processor, further cause said processor to instruct said robotic arm to present said machine-readable code to said at least one optical sensor, such that said at least one optical sensor is able to scan said machine-readable code.

119. The system of claim 116, further comprising a product database in communication with said computing device, wherein said product database comprises said one or more expected dimensions.

120. The system of claim 116, further comprising an operator device, wherein said instructions, when executed by said processor, further cause said processor to send alert information to said operator device when said alert is generated.

121. The system of claim 120, wherein said alert information comprises one or more images of said at least one of said one or more objects.

122. The system of claim 121, wherein said operator device comprises a user interface for receiving input from an operator, wherein said operator inputs verification of said alert.

123. The system of claim 122, wherein said verification trains a machine learning algorithm of said computer program.

124. The system of claim 122, wherein said verification comprises confirming if said alert was properly generated or rejecting said alert.

125. The system of claim 112, wherein said processor of said computing device is operatively coupled to said at least one optical sensor, and wherein said instructions, when executed by said processor, further cause said processor to analyze images received by said at least optical sensor to obtain one or more grasping points on at least one of said one or more objects for said end effector.

126. The system of claim 112, further comprising at least one force sensor configured to obtain a measured force of at least one of said one or more objects from said at least one effector handles, and wherein said instructions, when executed by said processor, further cause said processor to analyze a force differential of said measured force and an expected force of an object being handled and either (a) instruct said robotic arm to place said object being handled at said target position, or (b) generate an alert.

127. A computer-implemented method for detecting anomalies in one or more objects being sorted, comprising:
grasping each object of said one or more objects with a robotic arm;
measuring one or more forces corresponding with said grasping of each object with a force sensor disposed on said robotic arm;
analyzing a force differential between a measured force of said one or more forces and corresponding expected force; and
generating an anomaly alert if said force differential exceeds a predetermined force threshold.

128. The computer-implemented method of claim 127, further comprising imaging each object of said one or more objects with one or more image sensors.

129. The computer-implemented method of claim 128, further comprising analyzing one or more images of each object of said one or more objects to select an end effector for said robotic arm.

130. The computer-implemented method of claim 128, further comprising:
analyzing a dimensional differential between one or more measured dimensions and one or more corresponding expected dimensions; and
generating said anomaly alert if said dimensional differential exceeds a predetermined dimension threshold.

131. The computer-implemented method of claim 130, further comprising:
scanning a machine readable-code marked on each object of said one or more objects; and
obtaining said one or more corresponding expected dimensions.

132. The computer-implemented method of claim 128, further comprising scanning a machine readable-code marked on each object of said one or more objects.

133. The computer-implemented method of claim 132, further comprising obtaining said corresponding expected force for each object of said one or more objects from said machine readable code.

134. The computer-implemented method of claim 133, further comprising generating said anomaly alert if said machine-readable code is different than one or more expected machine-readable code.

135. The computer-implemented method of claim 127, further comprising verifying said anomaly alert.

136. The computer-implemented method of claim 135, further comprising training a machine-learning algorithm based at least in part on one or more of: a measured force, said force differential, or said verification of said anomaly alert.

137. The computer-implemented method of claim 127, wherein said one or more forces comprise a weight of said object of said one or more objects.

138. The computer-implemented method of claim 127, wherein measuring one or more forces of each object of said one or more objects is carried out as said robotic arm moves each object of said one or more objects from a first position to a target position.

139. The computer-implemented method of claim 138, wherein said target position is within a target container.

140. The computer-implemented method of claim 127, further comprising transmitting an object status to an object tracking system.

141. The method of claim 140, wherein the object status comprises one or more of: confirmation of an object of said one or more objects being placed at a target position, input that an anomaly has been detected, input that said object of said one or more objects has been placed at an exception location, or input that said object of said one or more objects has left said target position.
